(19) United States
(12) Patent Application Publication
(10) Pub. No.: US 2012/0162023 A1
(43) Pub. Date: Jun. 28, 2012

(54) MULTI-BAND ANTENNA

(75) Inventor: LUNG-SHENG TAI, New Taipei (TW)

(73) Assignee: HON HAI PRECISION INDUSTRY CO., LTD., New Taipei (TW)

(21) Appl. No.: 13/336,469

(22) Filed: Dec. 23, 2011

(30) Foreign Application Priority Data
Dec. 23, 2010 (TW) 099145491

(51) Int. Cl. H01Q 9/04

(52) U.S. Cl. 343/700 MS

(57) ABSTRACT

A multi-band antenna includes a main body and a metal foil. The main body includes a first radiating element and a second radiating element separated from the first radiating element to form an opening therebetween. The metal foil has a slot connected to the opening of the main body.

### BACKGROUND OF THE INVENTION

1. Field of the Invention

The present invention relates generally to a multi-band antenna, and more particularly to a multi-band antenna with an improved grounding element.

2. Description of the Prior Art

The movable electrical device, such as notebook, used to use antennas to wirelessly transmit signals. The antennas is easily influenced by components therearound in the electrical device. An antenna could present different performances in different electrical devices. Thus, an antenna is need to be made micro suitable changed to fit for different environments in the electrical devices. The Planar Inverted-F Antenna (PIF antenna) is a type of normal low-profile antenna used in movable terminal device. The PIF antennas always have low profile, light weight for saving space in the movable terminal device, reducing producing cost, being fit for multi frequency bands. The PIF antennas always at least comprises a radiating element, a connecting element and a grounding element. However, the normal PIF antennas fail to own adjustable impedance for fit for different environments.

Hence, in this art, an improved multi-band antenna to overcome the above-mentioned disadvantages of the prior art should be provided.

### BRIEF SUMMARY OF THE INVENTION

A primary object, therefore, of the present invention is to provide a low-profile antenna with an improved connecting element.

In order to implement the above object, the multi-band antenna comprises a main body and a metal foil. The main body comprises a first radiating element and a second radiating element separated from the first radiating element to form an opening therebetween. The metal foil has a slot connected to the opening of the main body.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view illustrating a multi-band antenna according to a preferred embodiment of the present invention;

FIG. 2 is a partly, assembly perspective view illustrating a multi-band antenna according to a preferred embodiment of the present invention;

FIG. 3 is an exploded, perspective view of FIG. 1;

FIG. 4 is an exploded, perspective view similar to FIG. 3, but viewed from another angle;

FIG. 5 is an exploded, perspective view similar to FIG. 3, but viewed from another angle; and

FIG. 6 is a test chart recording for an antenna of the multi-band antenna of FIG. 1, showing Voltage Standing Wave Ratio (VSWR) as a function of Wireless Wide Area Network frequency.

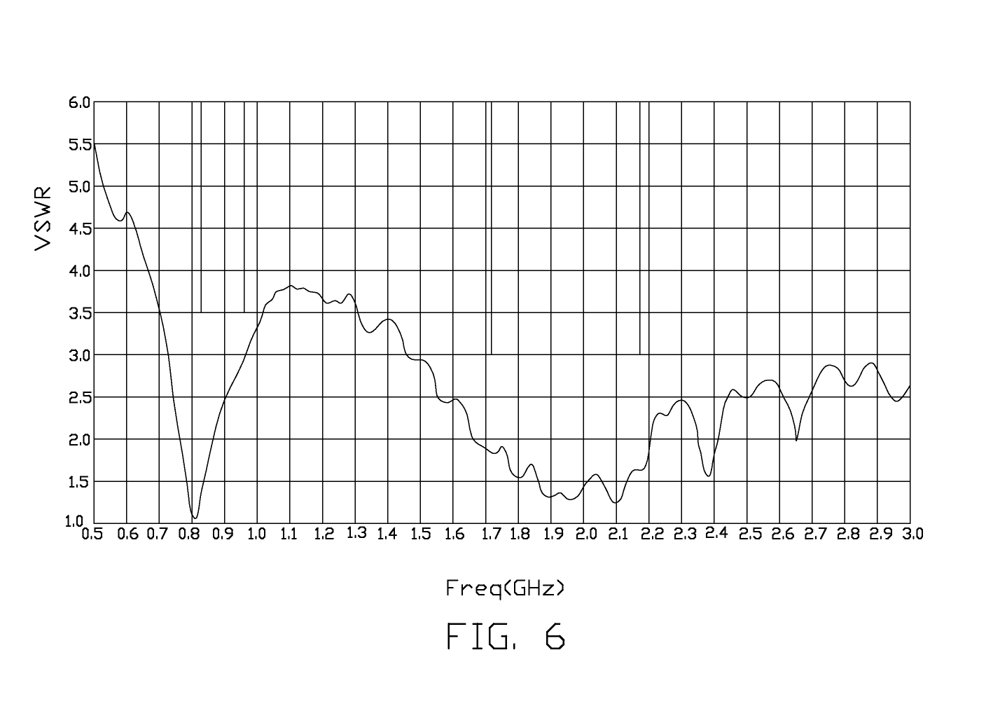

### DETAILED DESCRIPTION OF THE INVENTION

Reference will now be made in detail to a preferred embodiment of the present invention.

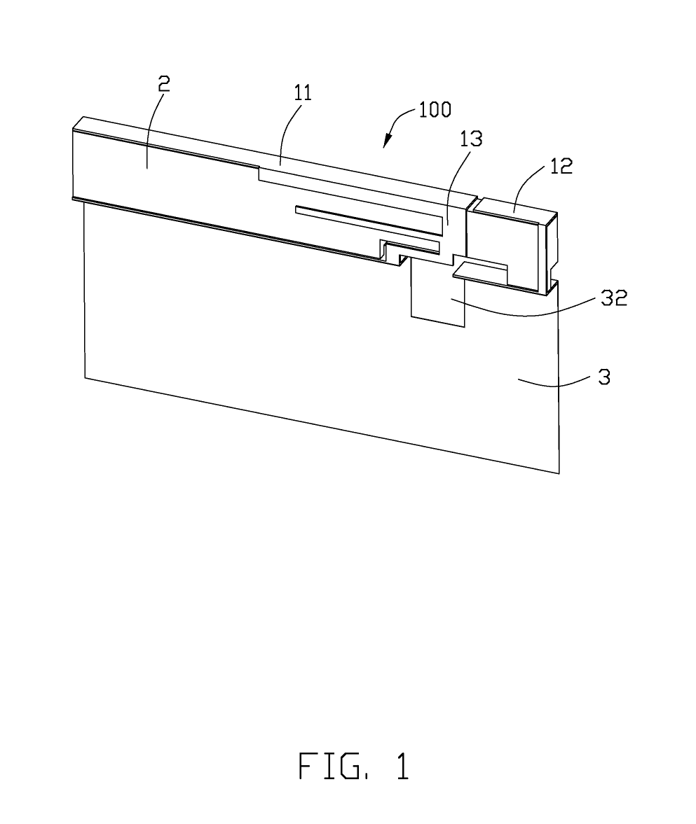

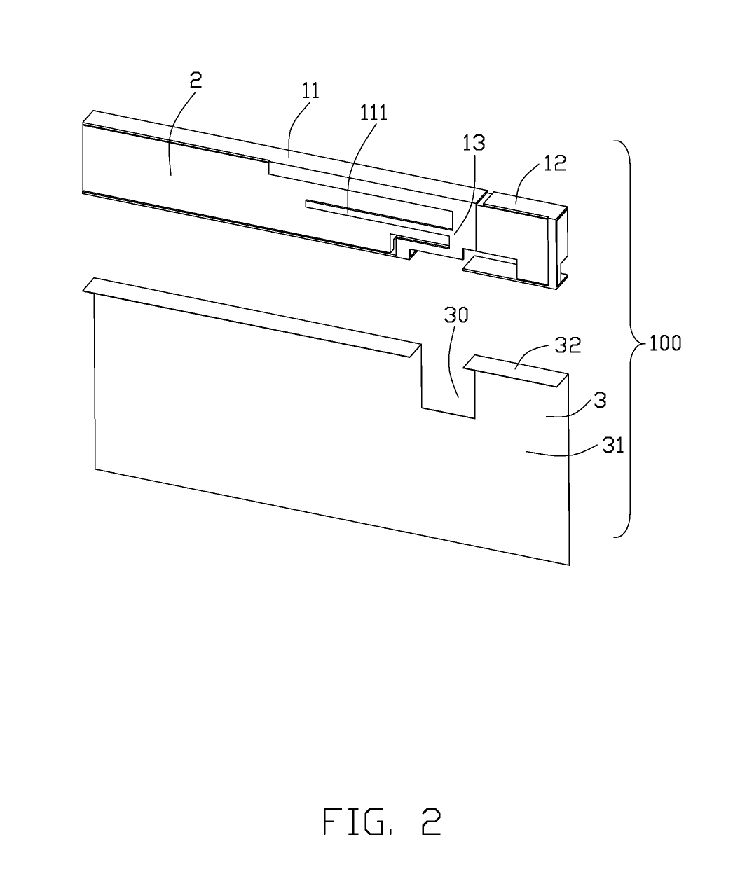

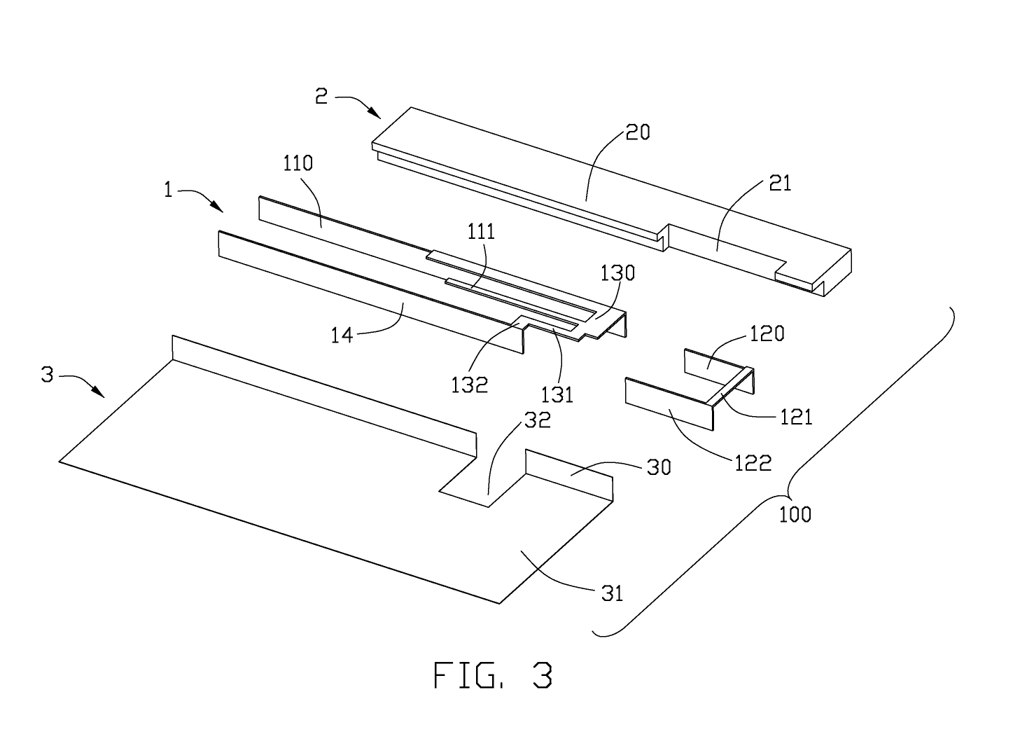

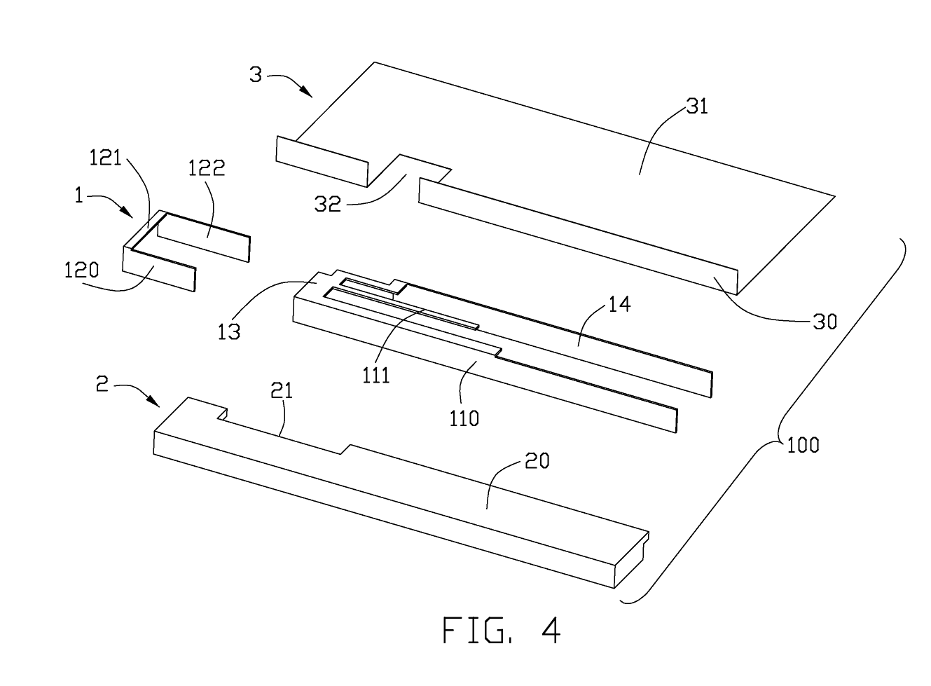

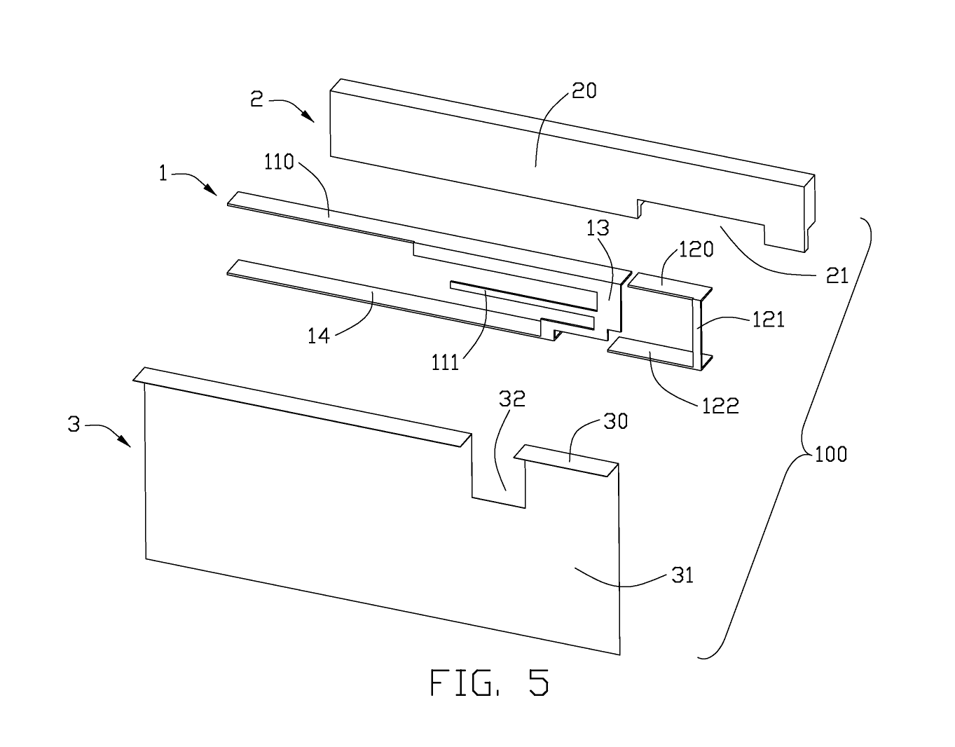

Reference to FIGS. 1 to 5, a multi-band antenna 100 comprises a main body 1, a supporting portion 2 and a metal foil 3.

The main body 1 comprises a first radiating element 11 and a second radiating element 12 separated from the first radiating element 11 to form an opening (not labeled) therebetween. The first radiating element 11 comprises a first radiating portion 110 extending along a lengthwise direction and a second radiating portion 111 extending along the lengthwise direction. The second radiating portion 111 is located on a plane perpendicular to a plane which the first radiating portion 110 is located on, and the second radiating portion 111 is shorter than the first radiating portion 110. A connecting element 13 is connected to the first radiating portion 110 and the second radiating portion 111. The second radiating element 12 comprises a radiating arm 120 extending toward to the first radiating portion 110 and separated from the first radiating portion 110, a connecting arm 121 extending along a horizontal direction perpendicular to the radiating arm 120 and a grounding portion 122 extending along the lengthwise direction. The first radiating portion 110 works on a lower first frequency band and the second radiating portion 111 and the second radiating arm 120 together operate at a higher second frequency band.

The connecting element 13 comprises a connecting arm 130, a second connecting arm 131 and a third connecting arm 132. The first connecting arm 130 is connected to the first radiating portion 111 and the second connecting arm 131. The second connecting arm 131 is narrower than the first connecting arm 131. The second connecting arm 131, the third connecting arm 132 extend along a direction perpendicular to the first radiating portion 110. The second connecting arm 131 is of L shape and extends perpendicular to the first connecting arm 130 and the third connecting arm 132. A grounding element 14 is formed to be connected to the third connecting arm 132. The third connecting arm 132 is between the second connecting arm 131 and the grounding element 14. A opening or space (not labeled) is formed between the grounding element 14 and the grounding portion 122.

The supporting portion 2 comprises an upper surface 20 and a rectangular gap or recess 21 located on one side of the opening The main body 1 is located around the supporting portion 2 with the first radiating portion 110, the radiating arm 120 located on a plane parallel to a plane the grounding element 14 and the grounding portion 122 located on. A part of the grounding element 14 and the grounding portion 122 are exploded below the gap 21.

The metal foil 3 is made from an integrated aluminous foil or an integrated copper foil and comprises a mating portion 30 extending along the plane which the first radiating portion 110 located on and a main portion 31 extending along a plane perpendicular to the plane which the first radiating portion 110 is located on. A cutout 32 is formed on the metal foil 3 to correspond to the gap 21. The cutout 32 is of L-shaped configuration viewed from a side view and connected to the gap 21 of the supporting portion 2. The mating portion 30 is attached to the grounding element 14 and the grounding portion 122.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-band antenna, comprising:
a main body comprising a first radiating element and a second radiating element separated from the first radiating element to form an opening therebetween;
a metal foil having a slot connected to the opening of the main body.

2. The multi-band antenna as claimed in claim 1, wherein said slot is of L-shaped configuration viewed from a side view and connected to the gap of the supporting portion.

3. The multi-band antenna as claimed in claim 2, wherein said first radiating element comprises a first radiating portion extending along a lengthwise direction and a second radiating portion extending along the lengthwise direction, the second radiating portion is located on a plane perpendicular to a plane which the first radiating portion is located on, the second radiating portion is shorter than the first radiating portion.

4. The multi-band antenna as claimed in claim 3, wherein said main body further comprises a connecting element connected to the first radiating portion and the second radiating portion and a grounding element connected to the connecting element, the second radiating element comprises a radiating arm extending toward to the first radiating portion and separated from the first radiating portion, a connecting arm extending along a horizontal direction perpendicular to the radiating arm and a grounding portion extending along the lengthwise direction.

5. The multi-band antenna as claimed in claim 4, wherein said first radiating portion works on a lower first frequency band and the second radiating portion and the second radiating arm together operate at a higher second frequency band.

6. The multi-band antenna as claimed in claim 4, wherein said connecting element comprises a connecting arm, a second connecting arm and a third connecting arm said first connecting arm is connected to the first radiating portion and the second connecting arm.

7. The multi-band antenna as claimed in claim 6, wherein said second connecting arm is narrower than the first connecting arm.

8. The multi-band antenna as claimed in claim 7, wherein the first connecting arm, the third connecting arm extend along a direction perpendicular to the first radiating portion.

9. The multi-band antenna as claimed in claim 8, wherein said second connecting arm is of L shape and extends perpendicular to the first connecting arm and the third connecting arm, the third connecting arm is connected to the second connecting arm and the grounding element.

10. The multi-band antenna as claimed in claim 4, wherein said opening is located between the grounding element and the grounding portion.

11. The multi-band antenna as claimed in claim 4, wherein said cutout is of L-shaped configuration viewed from a side view.

12. The multi-band antenna as claimed in claim 11, wherein said supporting portion comprises an upper surface and a rectangular gap located on one side of the cutout, the main body is located around the supporting portion with the first radiating portion, the radiating arm located on a plane parallel to a plane the grounding element and the grounding portion located on.

13. The multi-band antenna as claimed in claim 12, wherein said cutout is connected to the gap of the supporting portion.

14. The multi-band antenna as claimed in claim 13, wherein said a part of the grounding element and the grounding portion are exploded below the gap.

15. The multi-band antenna as claimed in claim 12, wherein said a part of the grounding element and the grounding portion are exploded below the gap.

16. The multi-band antenna as claimed in claim 4, wherein the metal foil comprises a mating portion extending along the plane which the first radiating portion located on and a main portion extending along a plane perpendicular to the plane which the first radiating portion is located on.

17. A multi-band antenna comprising:
an insulator including thereon a plurality of exterior supporting surfaces defined by first, second and third directions perpendicular to one another;
first and second radiating elements discrete from each other and side by side arranged each other in the first direction with an irregular space therebetween in the first direction while commonly mounted upon exterior supporting surfaces the insulator, each of said first and second radiating elements seated upon more than one of said exterior supporting surfaces; and
a metallic grounding element connected to both said first radiating element and said second radiating element in the second direction; wherein the grounding element defines a cutout directly communicating with said space in the second direction in a front view taken along the third direction.

18. The multi-band antenna as claimed in claim 17, wherein said insulator defines a recess around the space and communicating with the cutout in the second direction.

19. The multi-band antenna as claimed in claim 18, wherein one of the first and second radiating elements communicates with said recess in said third direction.

20. The multi-band antenna as claimed in claim 17, wherein each of said first radiating element and said second radiating element defines a U-shaped configuration in a side view taken along the first direction.
